(19) United States
(12) Patent Application Publication
(10) Pub. No.: US 2007/0297365 A1
(43) Pub. Date: Dec. 27, 2007

(54) Control message exchange for wireless devices using directional and omni-directional transmissions

(76) Inventors: Guoqing C. Li, Portland, OR (US); Liuyang Lily Yang, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/477,079

(22) Filed: Jun. 27, 2006

(51) Int. Cl. H04Q 7/00

(52) U.S. Cl. 370/331; 455/456.1

(57) ABSTRACT

According to some embodiments, directional and omni-directional messages are exchanged between two nodes during a control message exchange procedure in a wireless network. In other embodiments, only directional messages may be exchanged during the control message exchange. These directional and omni-directional control messages are used to provide location information to neighboring nodes which may overhear the control messages. The neighboring nodes may then be permitted transmit and receive in certain modes, depending on their location relative to one another.

### FIELD

Embodiments disclosed herein relate to directional antenna technology for wireless devices.

### BACKGROUND

Directional antenna technology offers the promises of increased signal quality through beamforming gain or diversity gain, reduced interference through null steering, and hence increased spatial reuse to improve wireless network performance. As directional antenna technology is increasingly used in non-802.11 networks, and has been studied for use in 802.11 networks, it becomes necessary to re-examine the current 802.11 Medium Access Control (MAC), as the current 802.11 MAC was not designed with directional antenna use in mind.

In random access networks, control messages are used as part of handshake mechanisms to prevent collisions of longer data packets. These control messages, e.g., Request to Send (RTS) and Clear to Send (CTS) as defined by the Institute of Electrical and Electronics Engineers, Inc. (IEEE) 802.11 standards for wireless local area networks (WLANs) such as the IEEE 802.11 standard (1999 Edition, Information Technology Telecommunications and Information Exchange Between Systems—Local and Metropolitan Area Networks—Specific Requirements, Part 11: WLAN Medium Access Control (MAC) and Physical (PHY) Layer Specifications), can be transmitted in either omni-directional or directional modes.

Transmitting RTS and CTS directionally can potentially increase spatial reuse, thus allowing more nodes to communicate simultaneously. However, transmitting RTS and CTS directionally can cause deafness to other nodes, as illustrated in FIG. 1.

Here, node A (102) is transmitting to and receiving from node B (104) using a directional antenna having antenna coverage (110) in the direction of node B (104). If node C (106) is unaware of this on-going transmission, and if it would like to commence communications with node A (102), node C (106) will transmit a RTS message (112) to node A (102). Because node A (102) is receiving only from the direction of node B (104), it is “deaf” to node C's transmission. Furthermore, the use of a directional antenna by node A makes node C unaware of the node A's on-going communications with node B, and also unaware of the deafness at node A. Deafness may cause unproductive retransmissions, which may further lead to a misleading effect in the neighborhood, such as at node D (108).

### BRIEF DESCRIPTION OF THE DRAWINGS

A better understanding of the present invention can be obtained from the following detailed description in conjunction with the following drawings, in which:

FIG. 1 is an illustration of a wireless system utilizing directional transmission according to some embodiments.

FIG. 2 is a flow diagram illustrating the message exchange sequence between two nodes according to some embodiments.

FIG. 3 is an illustration of the control message exchange sequence between two nodes according to some embodiments.

FIGS. 4-8 are diagrams illustrating device location regions relative to the transmission coverage of two nodes, A and B according to some embodiments.

FIGS. 9 and 10 are simplified block diagrams of nodes according to some embodiments.

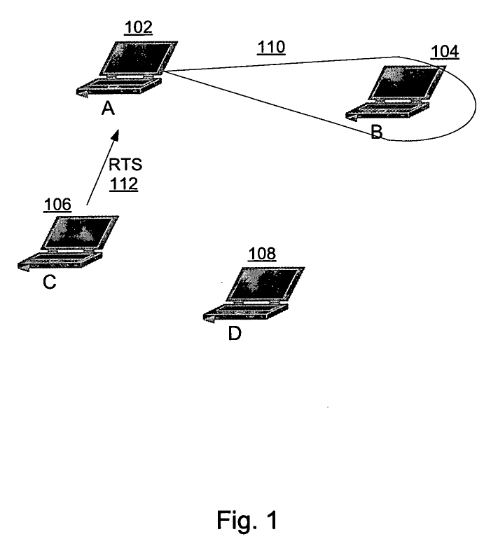

### DETAILED DESCRIPTION

In the following description, for purposes of explanation, numerous details are set forth in order to provide a thorough understanding of embodiments of the present invention. However, it will be apparent to one skilled in the art that these specific details are not required in order to practice the present invention as hereinafter claimed.

Embodiments of the present invention concern the exchange of control messages between nodes in a wireless network. Although the following discussion centers on 802.11 based ad hoc/mesh wireless devices and networks, it will be understood by those skilled in the art that embodiments may be practiced in support of any type of wireless network requiring a handshake or negotiation process before commencing communication between two nodes. According to some embodiments, both directional and omni-directional messages are exchanged between two nodes during a control message exchange procedure. In other embodiments, only directional messages may be exchanged during the control message exchange. These directional and omni-directional control messages are used to provide location information to neighboring nodes. The control messages may further be used to provide other information to the neighboring nodes, including, but not limited to transmission duration between the two nodes.

A directional antenna is one that is capable of transmitting and/or receiving signals more effectively in a particular direction. Thus, a directional signal or a directional message is one that is transmitted and/or received by a directional antenna in a particular direction. An omni-directional antenna is one that is capable of transmitting and/or receiving signals in all directions. Thus, an omni-directional signal or omni-directional message is one that is transmitted and/or received by an omni-directional antenna in all directions.

In various embodiments, one or more neighboring nodes may overhear the control messages, and may use these messages to determine their location(s) relative to the nodes exchanging control messages. More specifically, in some embodiments, each of the neighboring nodes may determine that they are located within one of eleven possible regions relative to the nodes exchanging control messages. In other embodiments, more or fewer than eleven regions may be defined. Transmission rules based on the relative location of the nodes may specify whether the neighboring node may subsequently initiate a new transmission, and if so, which transmission mode may be used.

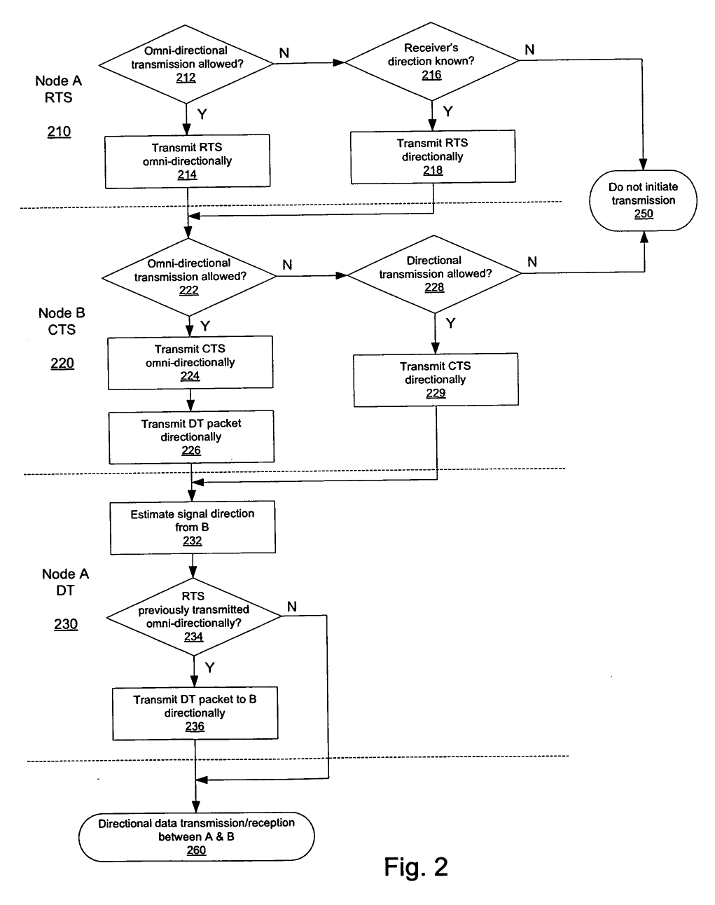

FIG. 2 is a flow diagram illustrating the exchange of control messages between two nodes (e.g., devices) in a wireless network, Node A and Node B, when Node A wants to transmit data to Node B. Region 210 of the flow diagram illustrates the transmission of the Request to Send (RTS) control packet from Node A to Node B.

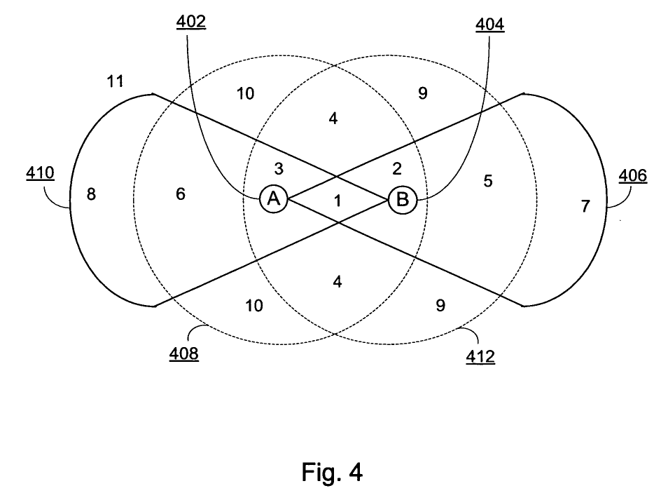

Before Node A may transmit the RTS packet, it must determine whether omni-directional transmission is allowed (block 212). In some embodiments, omni-directional transmission by Node A will be allowed if Node A has no location information for its position relative to other nodes, or if Node A is aware of its location with respect to two or more neighboring, communicating nodes based on overheard messages, and its location is outside of the directional coverage area of the neighboring, communicating nodes. Transmission rules for nodes that overhear control messages are described in more detail below, in conjunction with FIGS. 4-8.

If omni-directional transmission is allowed, then Node A may transmit the RTS packet omni-directionally (block 214). If omni-directional transmission is not allowed based on transmission rules, Node A must determine if the receiver's (e.g, Node B) direction is known (block 216). If the receiver's direction is known (e.g., based on a neighbor discovery process) and the directional information is regarded as fresh, then Node A may transmit the RTS packet directionally, in the direction of the receiver, Node B (block 218).

Directional information may be regarded as fresh if it was obtained less than a predetermined time before the present time, such as, for example, within the previous T seconds, where T is a number representing a time value. In some embodiments, a node may include one or more timers to indicate whether directional information is fresh. When directional information is obtained, the timer may be reset to a predetermined time value, T. The newly obtained directional information may be stored in the node. In some embodiments, the directional information may be stored, for example, in a table or a register in the node. Before the timer expires, the directional information may be regarded as fresh. After the timer expires, the information may be regarded as outdated. The outdated directional information may be purged, replaced, or otherwise invalidated, or may be stored by the node for another purpose, such as, for example statistical data gathering. The directional information may be updated, and the timer(s) reset each time a packet is received or overheard from another node. In other embodiments, other hardware, software, and/or firmware, or any combination thereof may be used to determine freshness of directional information.

The mode of RTS transmission (e.g., directional or omni-directional) may be distinguished based on the information contained within the RTS packet. In some embodiments, the RTS packet may include a field indicating whether the RTS transmission was directional or omni-directional. This information may be used by nodes which overhear the transmission.

If omni-directional transmission is not allowed, and the receiver's direction is unknown, then Node A may not initiate a transmission (block 250).

Region 220 of the flow diagram illustrates the transmission of the Clear to Send (CTS) control packet from Node B to Node A, after Node B has received the RTS packet from Node A.

Before Node B may transmit the CTS packet, it must determine whether omni-directional transmission is allowed (block 222). In some embodiments, omni-directional transmission by Node B will be allowed if Node B has no location information for its position relative to other nodes, or if Node B is aware of its location with respect to two or more neighboring, communicating nodes based on overheard messages, and its location is outside of the directional coverage area of the neighboring, communicating nodes. Transmission rules for nodes that overhear control messages are described in more detail below, in conjunction with FIGS. 4-8.

If omni-directional transmission is allowed, then Node B may transmit the CTS packet omni-directionally (block 224). Node B may also directionally transmit a direction test (DT) packet to Node A (block 226). In some embodiments, the DT packet contains an identifier for the sender of the packet, and is transmitted directionally from the transmitter to the receiver. In various embodiments, the directional transmission of the DT packet may follow an omni-directional CTS transmission. The DT packet is transmitted directionally, and is used to allow neighbors to evaluate their locations relative to Nodes A and B. Thus, if CTS is transmitted directionally, it is not necessary to send a DT packet.

If omni-directional transmission is not allowed based on transmission rules, Node B must determine if the transmission rules allow a directional transmission in the direction of Node A (block 228). If permitted by the transmission rules, Node B may transmit the CTS packet directionally, in the direction of the receiver, Node A (block 229).

The mode of CTS transmission (e.g., directional or omni-directional) may be distinguished based on the information contained within the CTS packet. In some embodiments, the CTS packet may include a field indicating whether the CTS transmission was directional or omni-directional. This information may be used by nodes which overhear the transmission.

If neither omni-directional nor directional transmission of CTS is allowed, then Node B may not initiate a transmission of the CTS packet (block 250).

Region 230 of the flow diagram illustrates the actions of Node A after CTS have been received from Node B. Node A may estimate the signal direction from Node B (block 232). In various embodiments, the signal direction estimation is based on a directional transmission from Node B that is received at Node A. The directional transmission may be either that of the DT packet or the CTS packet.

After Node A has estimated a signal direction from Node B, Node A may directionally transmit a DT packet to Node B (block 236) if Node A previously transmitted the RTS packet omni-directionally (block 234). This ensures that there has been both a directional transmission from Node B to Node A and a directional transmission from Node A to Node B during the control message exchange sequence.

Nodes A and B may then commence directional transmission and reception of data (block 260).

Thus, during the exchange of control messages, it is possible to have both directional and omni-directional transmissions from both Node A and Node B. This allows neighboring nodes who overhear the Node A-B control message exchange to gain information about their locations. This information may be used by the neighboring nodes in determining whether they are permitted to initiate future directional or omni-directional transmissions.

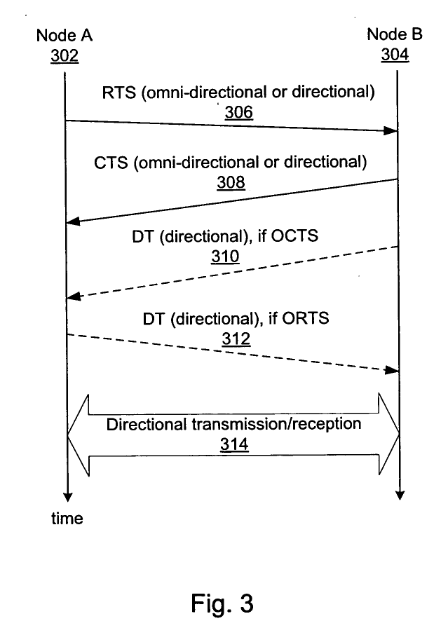

FIG. 3 is another illustration of the control message exchange sequence between two nodes/devices according to some embodiments. When Node A (302) desires to communicate with Node B (304), Node A transmits a RTS packet (306) to Node B. The RTS packet may be transmitted directionally or omni-directionally, depending on the transmission rules that apply to Node A as described above.

After Node B receives the RTS packet, Node B transmits a CTS packet (308) to Node A. Again, the CTS packet may be transmitted directionally or omni-directionally, depending on the transmission rules that apply to Node B as described above.

If Node B transmits the CTS packet omni-directionally, the omni-directional CTS transmission will be followed by a directional direction test (DT) packet transmission (310). The DT packet allows neighboring nodes to determine their position with respect to Node B.

After Node A receives the CTS packet and optionally receives the DT packet from Node B, Node A will then directionally transmit a DT packet to Node B (312) if the previous RTS transmission was omni-directional. If there was a previous directional transmission from Node A to Node B, Node A need not transmit the DT packet.

Finally, after the control message exchange sequence has completed, Node A and Node B may directionally transmit and receive data to and from one another (314).

Other nodes in the neighborhood of Node A and Node B may overhear the control message exchange between the nodes. A node that overhears the control message exchange may then use the overheard messages to estimate the location of the signal sources, thus allowing the node to determine its location with respect to Node A and Node B.

An overhearing node may also use the overheard messages to determine which region it is located in with respect to Node A's and Node B's transmission coverage area.

FIG. 4 illustrates eleven possible regions where a node may be located relative to Node A (402) and Node B (404). Node A's coverage area using an omni-directional antenna is illustrated by circle 408. Thus, when Node A transmits an omni-directional transmission, such as an omni-directional RTS packet, the packet is transmitted over region 408 and will be overheard by any nodes within region 408. Similarly, Node B's coverage area using an omni-directional antenna is illustrated by circle 412. Thus, when Node B transmits an omni-directional transmission, such as an omni-directional CTS packet, the packet is transmitted over region 412 and will be overheard by any nodes within region 412. Circles 408 and 412 represent omni-directional coverage areas where the center of the coverage area is the transmitting node.

Node A's coverage area using a directional antenna is illustrated by cone 406, where the cone represents the coverage area using a directional antenna with the apex being the transmitting node. Thus, when Node A transmits a directional transmission, such as a directional RTS packet or DT packet, the packet is transmitted over region 406 and will be overheard by any nodes within region 406. Similarly, Node B's coverage area using a directional antenna is illustrated by cone 410. Thus, when Node B transmits a directional transmission, such as a directional CTS packet or DT packet, the packet is transmitted over region 410 and will be overheard by any nodes within region 410.

Numerals 1-11 on the diagram indicate the different regions where a node may be located with respect to Nodes A and B. A node may determine which region it is located in by evaluating the overheard messages from Nodes A and B. For example, a node located in region 5 would overhear only directional transmissions by Node A and omni-directional transmissions by Node B. Similarly, a node located in region 8 would overhear only directional transmissions by Node B. A node located in region 11 would overhear no messages from Nodes A or B. Table 1, below, lists each region and the corresponding overheard control messages for a node in that region, assuming that Node A is the requesting node. A “1” in the table represents a message that may be overheard by a node in that region, and a “0” indicates that the message will not be overheard by a node in that region.

TABLE 1

| | | Omni- | Omni- | | |
|---|---|---|---|---|---|
| | | directional | directional | Directional | Directional |
| | | transmission | transmission | transmission | transmission |
| | | by Node A | by Node B | by Node A | by Node B |
| Region | | (RTS) | (CTS) | (RTS, DT) | (CTS, DT) |
| | 1 | 1 | 1 | 1 | 1 |
| | 2 | 1 | 1 | 1 | 0 |
| | 3 | 1 | 1 | 0 | 1 |
| | 4 | 1 | 1 | 0 | 0 |
| | 5 | 0 | 1 | 1 | 0 |
| | 6 | 1 | 0 | 0 | 1 |
| | 7 | 0 | 0 | 1 | 0 |
| | 8 | 0 | 0 | 0 | 1 |
| | 9 | 0 | 1 | 0 | 0 |
| | 10 | 1 | 0 | 0 | 0 |
| | 11 | 0 | 0 | 0 | 0 |

Thus, in various embodiments, a node may determine which region it belongs to by evaluation which of the control messages have been overheard (e.g., RTS, CTS, and/or DT) and the mode of transmission for each control message (e.g., directional transmission or omni-directional transmission).

In the case of a directional transmission by Node A, such as a directional RTS transmission or a directional DT transmission, region 10 will be regarded as region 11 because the two regions cannot be distinguished by the overheard messages. Similarly, region 6 will be regarded as region 8, and region 4 will be regarded as region 9 for the same reason. These regions within a pair are treated equally in transmission rules, thus they need not be distinguished.

In the case of a directional transmission by Node B, such as a directional CTS transmission or a directional DT transmission, region 9 will be regarded as region 11 because the two regions cannot be distinguished by the overheard messages. Similarly, region 5 will be regarded as region 7, and region 4 will be regarded as region 10 for the same reason. These regions within a pair are treated equally in transmission rules, thus they need not be distinguished.

In the case of a directional transmission by Node A, such as a directional RTS transmission or a directional DT transmission and a directional transmission by Node B, such as a directional CTS transmission or a directional DT transmission, regions 4, 9, 10, and 11 are indistinguishable, regions 2, 5, and 7 are indistinguishable, and regions 3, 6, and 8 are indistinguishable. Regions that are indistinguishable are treated equally in transmission rules.

After a neighboring node has determined which region it is located within, transmission rules for each region specify whether the node may initiate a new transmission, and if so, which transmission mode (e.g. directional or omni-directional) may be used. Thus, when a neighboring node initiates a new transmission, it will not interfere with or be interfered by the existing communicating nodes.

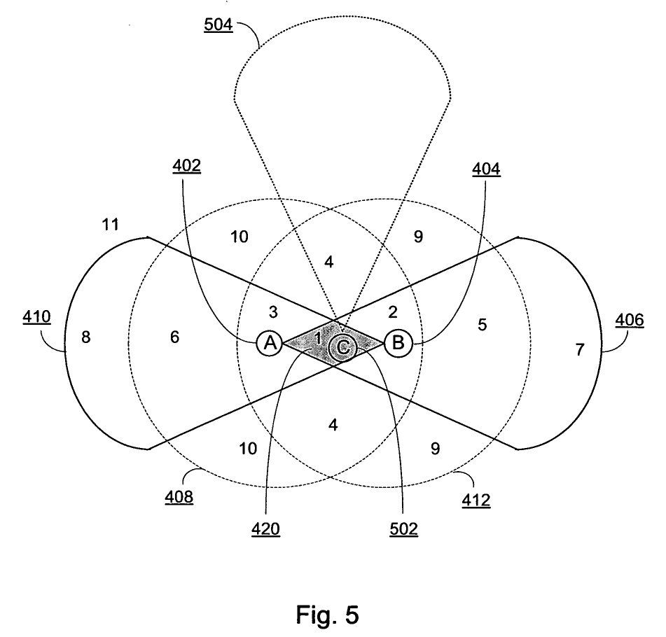

FIG. 5 illustrates the transmission rules for any node located within region 1 (420). A node located within region 1 may transmit and/or receive using only a directional antenna in directions other than toward Node A (402) or Node B (404). Or, in other words, a node located within region 1, such as Node C (502) may transmit in any direction that is away from Node A and Node B. For example, Node C may transmit the illustrated directional transmission (504). When a node, such as Node C, located within region 1 avoids transmitting to and receiving from of Nodes A and B, it will not interfere with A or B's transmission/reception. Furthermore, Nodes A and B will not interfere with Node C's transmission/reception.

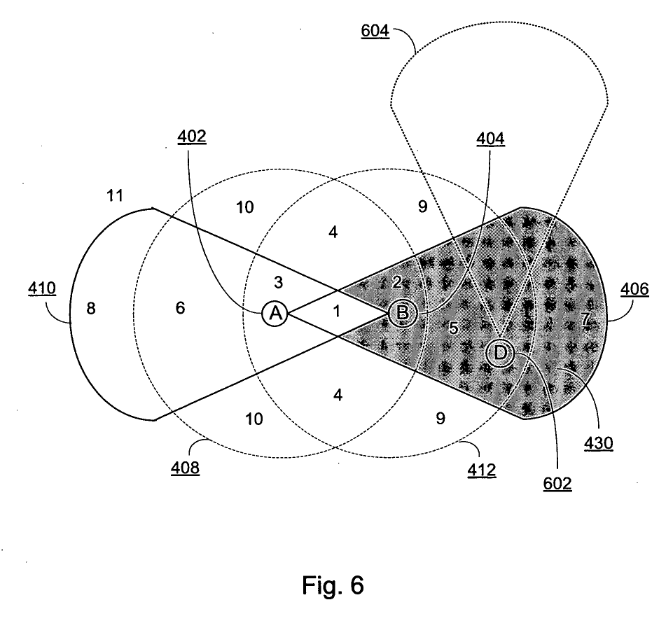

FIG. 6 illustrates the transmission rules for any node located within regions 2, 5, or 7 (430). A node located within regions 2, 5, or 7 may transmit and/or receive using only a directional antenna in directions other than toward Node A (402). In other words, a node located within regions 2, 5, or 7, such as Node D (602) may transmit in any direction that is away from Node A. For example, Node D may transmit the illustrated directional transmission (604). When a node, such as Node D, located within regions 2, 5, or 7 avoids transmitting to and receiving from of Node A, it will not interfere with A's transmission/reception. Furthermore, Node A will not interfere with Node D's transmission/reception.

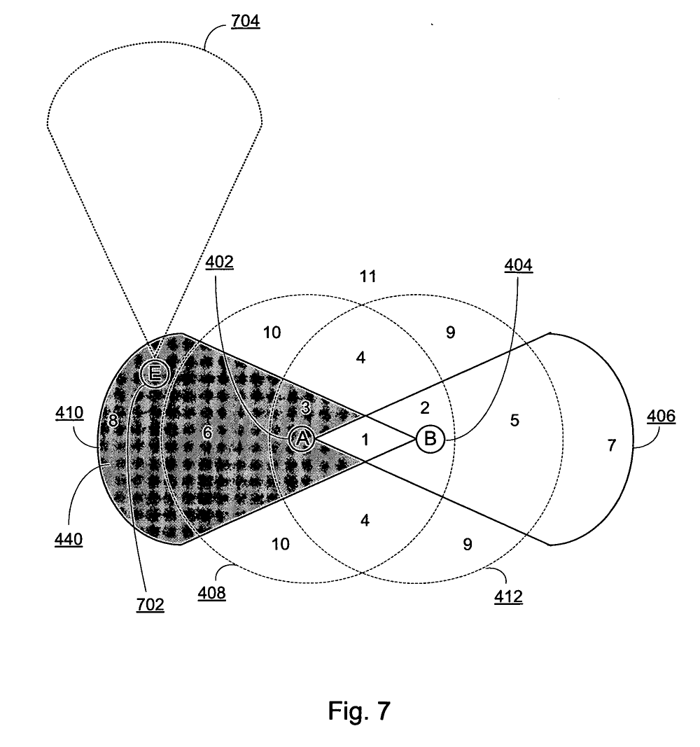

FIG. 7 illustrates the transmission rules for any node located within regions 3, 6, or 8 (440). A node located within regions 3, 6, or 8 may transmit and/or receive using only a directional antenna in directions other than toward Node B (404). In other words, a node located within regions 3, 6, or 8, such as Node E (702) may transmit in any direction that is away from Node B. For example, Node E may transmit the illustrated directional transmission (704). When a node, such as Node E, located within regions 3, 6, or 8 avoids transmitting to and receiving from the direction of Node B, it will not interfere with B's transmission/reception. Furthermore, Node B will not interfere with Node E's transmission/reception.

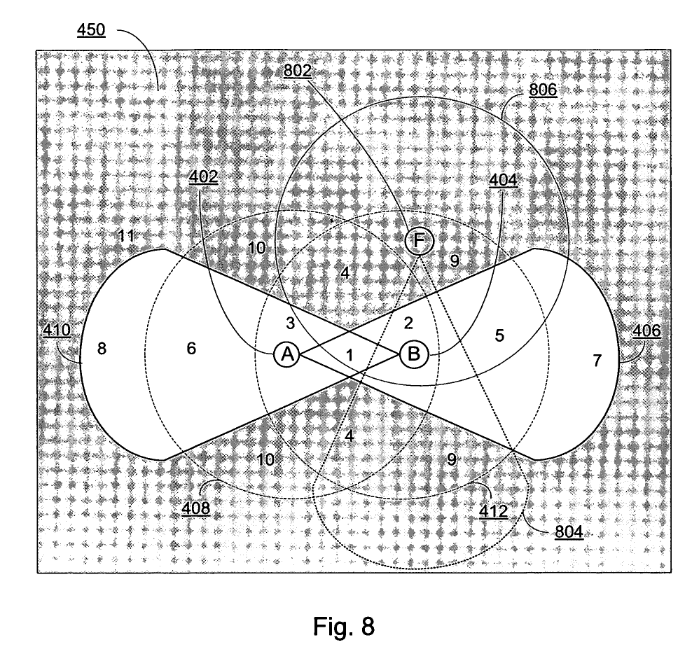

FIG. 8 illustrates the transmission rules for any node located within regions 4, 9, 10, or 11 (450). A node located within regions 4, 9, 10, or 11 may transmit and/or receive using either an omni-directional or a directional antenna in any direction. Thus, a node located within regions 4, 9, 10, or 11, such as Node F (802) may transmit in any direction and in any transmission mode. For example, Node F may transmit the illustrated directional transmission (804) and/or the illustrated omni-directional transmission (806). Nodes A and B will not be interfered with, even if they are in Node F's transmission coverage area, because Nodes A and B are communicating directionally and will reject any signals coming from another direction. Furthermore, Nodes A and B will not interfere with Node F's reception, because Nodes A and B do not transmit in Node F's direction.

Finally, nodes in all regions should avoid transmitting to Nodes A and B for a time period that is at least equal to any duration specified in control messages overheard by the neighboring node(s). This is because during this time period, Nodes A and B will be communicating with one another, and thus will be deaf to communications from another node.

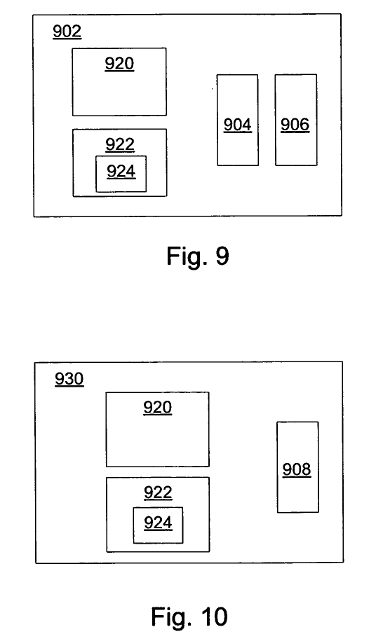

FIGS. 9 and 10 are simplified block diagrams of nodes according to some embodiments. FIG. 9 illustrates a node (902) according to various embodiments. The node may include two antennas, an antenna having directional transmission capability (904) and an antenna having omni-directional transmission capability (906), both antennas to support communication over a wireless communication link, such as, but not limited to, communications performed using the IEEE 802.11 protocol.

The node may further include a storage medium (922) to store logic for performing various operations associated with transmitting and receiving control messages and determining node location relative to other nodes, such as, for example, location identifier/transmission mode module (924). The storage medium (922) may be coupled to a processor (920) for carrying out instructions stored in the storage medium.

The machine-readable storage medium (922) may include one or more types of computer-readable storage media capable of storing data, including volatile memory or, non-volatile memory, removable or non-removable memory, erasable or non-erasable memory, writeable or re-writeable memory, and so forth. Examples of a machine-readable storage medium may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other type of computer-readable storage media suitable for storing information. Moreover, any media involved with downloading or transferring a computer program from a remote computer to a requesting computer carried by data signals embodied in a carrier wave or other propagation medium through a communication link (e.g., a modem, radio or network connection) is considered computer-readable storage media.

The machine-readable medium (922) may include logic comprising instructions, data, and/or code that, if executed by a machine, such as processor (920), may cause the machine to perform a method and/or operations in accordance with the described embodiments. Such a machine may include, for example, any suitable processing platform, computing platform, computing device, processing device, computing system, processing system, computer, processor, or the like, and may be implemented using any suitable combination of hardware and/or software.

FIG. 10 illustrates a node (930) according to various embodiments. The node may include a single antenna (908), having both directional and omni-directional transmission capability. The antenna is to support communication over a wireless communication link, such as, but not limited to, communications performed using the IEEE 802.11 protocol.

The node may further include a storage medium (922) to store logic for performing various operations associated with transmitting and receiving control messages and determining node location relative to other nodes, such as, for example, location identifier/transmission mode module (924). The storage medium (922) may be coupled to a processor (920) for carrying out instructions stored in the storage medium, as described above.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context. Furthermore, the terms “node” and “device,” are interchangeable, and in general refer to any apparatus having wireless communications capabilities.

It is also worthy to note that any reference to “one embodiment” or “an embodiment” means that a particular feature, structure, or characteristic described in connection with the embodiment is included in at least one embodiment. Thus, appearances of the phrases “in one embodiment” or “in an embodiment” in various places throughout the specification are not necessarily all referring to the same embodiment. Furthermore, the particular features, structures or characteristics may be combined in any suitable manner in one or more embodiments.

Thus, a method, apparatus, and system for control message exchange using directional and omni-directional transmission are disclosed. In the above description, numerous specific details are set forth. However, it is understood that embodiments may be practiced without these specific details. In other instances, well-known circuits, structures, and techniques have not been shown in detail in order not to obscure the understanding of this description. Embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

We claim:

1. A method comprising:
determining a location of a first node with respect to a second node and a third node using overheard messages from the second node and the third node;
determining a transmission mode for the first node based on the location of the first node; and
initiating a transmission from the first node using the determined transmission mode.

2. The method of claim 1, wherein the first node, the second node, and the third node transmit messages using the 802.11 protocol.

3. The method of claim 1, wherein the overheard messages include at least one of a Request to Send (RTS) message and a Clear to Send (CTS) message.

4. The method of claim 3, wherein the at least one of the RTS message and the CTS message contains a field indicating a mode of transmission for message.

5. The method of claim 3, wherein the overheard messages further include a direction test (DT) message.

6. The method of claim 5, wherein the DT message contains an identifier for a sender of the DT message.

7. The method of claim 3, wherein the transmission mode is directional in a direction away from the second node and the third node when the first node is in a first region.

8. The method of claim 7, wherein the first region is a region in which the first node overheard a directional RTS message from the second node and a directional CTS message from the third node.

9. The method of claim 3, wherein the transmission mode is directional in a direction away from the second node when the first node is in a second region.

10. The method of claim 9, wherein the second region is a region in which the first node overheard a directional RTS message from the second node.

11. The method of claim 3, wherein the transmission mode is directional in a direction away from the third node when the first node is in a third region.

12. The method of claim 11, wherein the third region is a region in which the first node overheard a directional CTS message from the third node.

13. The method of claim 3, wherein the transmission mode is omni-directional when the first node is in a fourth region.

14. The method of claim 13, wherein the fourth region is a region in which the first node overheard no directional message from the second node and the third node.

15. The method of claim 1, further comprising determining if transmission is permitted prior to determining a transmission mode.

16. The method of claim 1, wherein initiating a transmission comprises initiating a transmission to a fourth node.

17. A method comprising:
transmitting a Request To Send (RTS) message to a node;
receiving a Clear To Send (CTS) message from the node;
receiving a Direction Test (DT) packet from the node if the CTS message was an omni-directional CTS message; and
transmitting a DT packet to the node if the RTS message was an omni-directional RTS transmission.

18. The method of claim 17, further comprising directionally transmitting and directionally receiving data frames.

19. The method of claim 17, wherein transmitting the RTS message to the node comprises directionally transmitting the RTS message if omni-directional transmission is not permitted and if a direction for the node is known.

20. The method of claim 17, further comprising estimating a signal direction from the node prior to transmitting the DT packet to the node.

21. An system comprising:
a device;
an antenna having directional transmission capability coupled to the device to support communication over a wireless communication link; and
an antenna having omni-directional transmission capability coupled to the device to support communication over the wireless communication link, wherein the device is to transmit a Request To Send (RTS) message via the wireless communication link, to receive a Clear To Send (CTS) message via the wireless communication link, to receive a Direction Test (DT) packet via the wireless communication link if the CTS message was an omni-directional CTS message; and to transmit a DT packet using the directional antenna if the RTS message was transmitted via the omni-directional antenna.

22. The system of claim 21, wherein communication over the wireless communication link is performed using the IEEE 802.11 protocol.

23. The system of claim 21, wherein the antenna having directional transmission capability and the antenna having omni-directional transmission capability are the same antenna.

24. The system of claim 21, wherein the antenna having directional transmission capability and the antenna having omni-directional transmission capability are separate antennas.

25. An article of manufacture comprising a machine-accessible medium having stored thereon instructions which, when executed by a machine, cause the machine to:
determine a location with respect to a first node and a second node using overheard messages from the first node and the second node; and
determine a transmission mode based on the location.

26. The article of manufacture of claim 25, wherein the instructions, when executed by the machine, further cause the machine to initiate a transmission using the determined transmission mode.

27. An apparatus comprising:
a processor; and
a storage medium coupled to the processor, the storage medium to include logic to determine a location with respect to a first node and a second node using overheard messages from the first node and the second node, to determine a transmission mode based on the location, and to initiate a transmission using the transmission mode.

28. The apparatus of claim 27, wherein the overheard messages include at least one of a Request to Send (RTS) message and a Clear to Send (CTS) message.
